(19) United States
(12) Patent Application Publication
(10) Pub. No.: US 2009/0176386 A1
(43) Pub. Date: Jul. 9, 2009

(54) Electrical connector assembly with a reinforcing member facilitate contacting with a housing of mating connector

(75) Inventor: Chun-Kwan Wu, Tu-cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/319,295

(22) Filed: Jan. 5, 2009

(30) Foreign Application Priority Data
Jan. 5, 2008 (CN) 200820030615.9

(51) Int. Cl. H01R 12/02

(52) U.S. Cl. 439/74

(57) ABSTRACT

An electrical connector interconnection includes first and second connector. The first connector includes an insulative housing having a central slot with contact terminal arranged on sidewall thereof, the central slot having opposite first and second internal end portions. The first connector further includes first and second metallic aligning pad arranged on the internal end portion and the metallic aligning pad includes main plate substantially flush to an end wall of the end portion. The second connector mated with the first connector comprises a housing external end portion properly abutting against the metallic pads so as to facilitate smooth and correction interconnection between the first and second connector.

### BACKGROUND OF THE INVENTION

1. Field of the Invention

The present invention relates to an electrical connector assembly, and more particular to a board to board connector with a reinforcing member facilitate contacting with a housing of mating connector.

2. Description of the Related Art

The trend of the electronics is to constantly reduce the size of the electronic devices. Many electronics devices rely upon circuitry formed upon various printed circuit board. These printed circuit boards must be joined together with connectors in a manner to effectively and reliably interconnect the circuits on one circuit board to the circuits on another circuit board.

In order to permit the connection of two circuit boards in parallel planes and to reduce the size of the electronics devices, the connector industry developed the surface mount connector. A typical surface mount connector utilizes a plug-type male connector component that unites with an opposing receptacle-type, or female connector component. Both connector components are of low profile, allowing the circuit boards to be closely spaced to each other. When the connector components are engaged together, the mating terminals of the connector component form an electrical connection between the circuits of the two circuit boards.

U.S. Pat. No. 7,112,091 issued to Okura on Sep. 26, 2006, and entitled “Electric Connector Assembly with Improved Registration Characteristics”, discloses a board to board connector for connecting two circuit boards of a mobile equipment. The board to board connector is constituted by a header and socket. The header comprises a resin molded header body and a plurality of pairs of conductive terminals provided on the header body. The socket comprises a resin molded socket body and a plurality of sets of contacts provided on the socket body corresponding to the conductive terminals of the header. The header body and the socket body respectively have reinforcing member made of metal thin plate for reinforcing the header body and the socket body with respect to contortion or crack. Wherein the reinforcing member of the receptacle defines a hooking recess and the plug defines a hooking protrusion engaging with said hooking recess. Therefore, when the header is completely mated with the socket, the conductive terminals of the header are contacting engaging with the contacts of the socket, and the hooking protrusion of the header body is engaged with the hooking recess of the socket body.

U.S. Pat. No. 7,195,494 issued to Ookura on Mar. 27, 2007, and titled “Connector for Electrically Connecting Electronic Components”, also disclosed a board to board connector. Said connector includes a header and a socket. The socket includes a socket body with a plug groove and a plurality of socket contacts arranged in row lines along side walls of the socket body in longitudinal direction. The header includes a header body and a plurality of header posts arranged in two lines along both side walls of the header body in the longitudinal direction. In addition, a terminal reinforcing metal fitting for reinforcing the strength of the socket body to a circuit board is defined in both end portions of the socket body, wherein each terminal reinforcing metal fitting has a pair of fixed portion and a coupling portion of substantially reverse U-shape coupling between a pair of the fixed portion. And loss pins of the header serving as terminal reinforcing metal fitting are defined in both end portions of the header body, wherein the loss pins are formed on the same base metal as the header posts and has substantially the same cross-sectional shape as the header posts. Furthermore, each loss pin defines a fixed portion adapted for connecting with a printed circuit board. Therefore, when the terminal portions of the socket contacts and the header contacts are soldered on corresponding conductive pattern of the circuit boards, the fixed portion of the terminal reinforcing metal fittings and the loss pins are soldered on lands of the circuit board.

### BRIEF SUMMARY OF THE INVENTION

It is an object of the present invention to provide an electrical connector assembly with a reinforcing member contacting engaging with a housing of mating connector.

In order to achieve the objective above, an electrical connector in accordance with a preferred embodiment of the present invention is provided. The electrical connector comprises a housing with a plurality of terminal-receiving slots in which a plurality of conductive terminals is received, and a reinforcing member disposed on two end portions of the housing. The housing includes two sets of opposite first and second sidewalls, one set extending along a width direction and the other set extending along a length direction. A center pedestal is disposed between the opposite second sidewalls and the pedestal and the first and second sidewalls cooperately form a mating channel adapted for receiving a mating connector. Each conductive terminal includes a retention portion adapted for retaining the conductive terminal in the housing and a contact engaging portion for contacting engaging with a mating terminal of the mating connector. The reinforcing member includes a base portion exposured into the mating channel and a tail portion extending from a bottom surface to outside.

In order to achieve the objective stated above, an electrical connector assembly in accordance with a preferred embodiment of the present invention is provided. The electrical connector assembly includes a first and second connector adapted for interconnecting with each other and providing an electrical connection between two opposite printed circuit board. Each of the first and second connector includes a housing having a set of terminal-receiving slots in which a plurality of conductive terminals is received. One housing of the first and second connectors defines a mating opening formed by a set of sidewalls and a pedestal extending upwardly from a bottom wall adapted for receiving the other housing. Each conductive terminal of the first and second connector defines two opposite contact engaging portion for engaging with each other. One of the first and second connector further includes a reinforcing member with an elastic portion in order to contact engaging with the mating housing of the other connector.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like members in the figures and in which:

FIG. 1 is an exploded view of the plug connector according to the present invention;

FIG. 2 is perspective view of FIG. 1;

FIG. 3 is a partially enlarged view of FIG. 2;

FIG. 4 is a cross-section view of FIG. 2 along the line 4-4;

FIG. 5 is a cross-section view of the electrical connector assembly, wherein the plug connector has completely engaged with the receptacle connector;

FIG. 6 is a partially enlarged view of FIG. 5;

FIG. 7 is a cross-section view of the electrical connector assembly, wherein two opposite printed circuit board are shown together.

### DESCRIPTION OF PREFERRED EMBODIMENT OF THE INVENTION

In the following detailed description, for purposes of explanation, numerous specific details are set forth in order to provide a thorough understanding of the present invention.

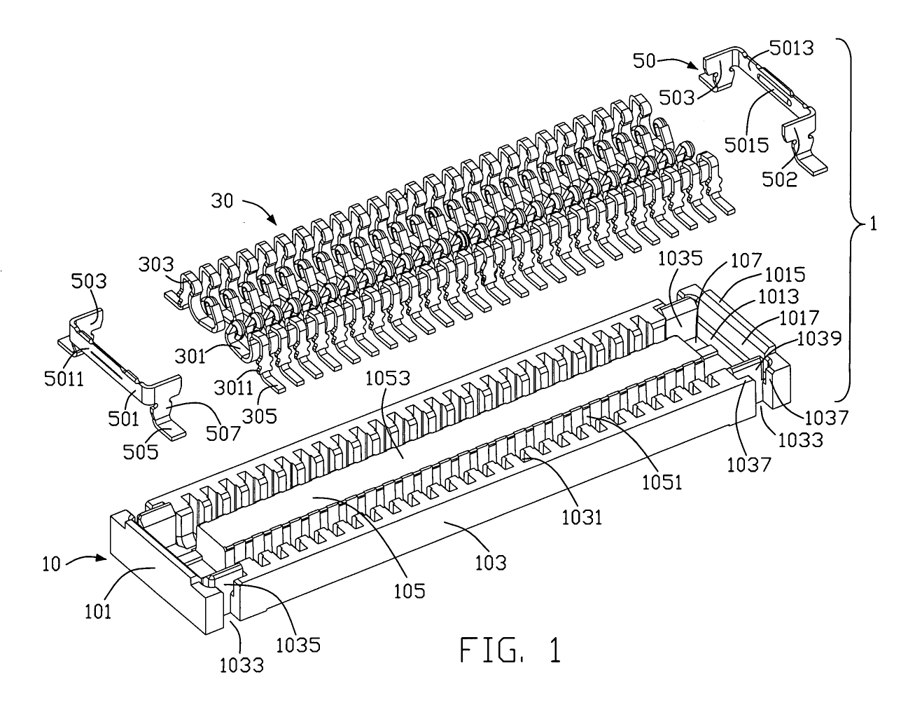

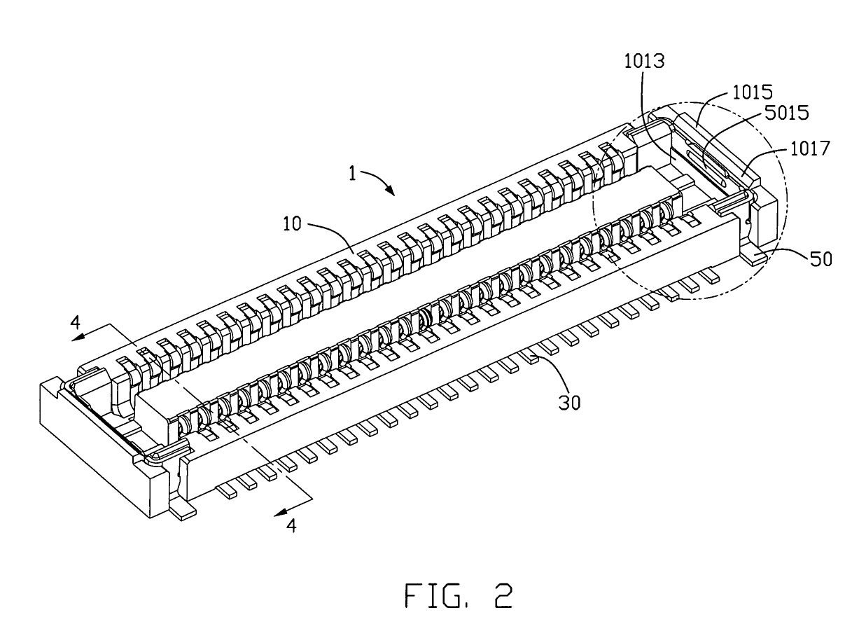

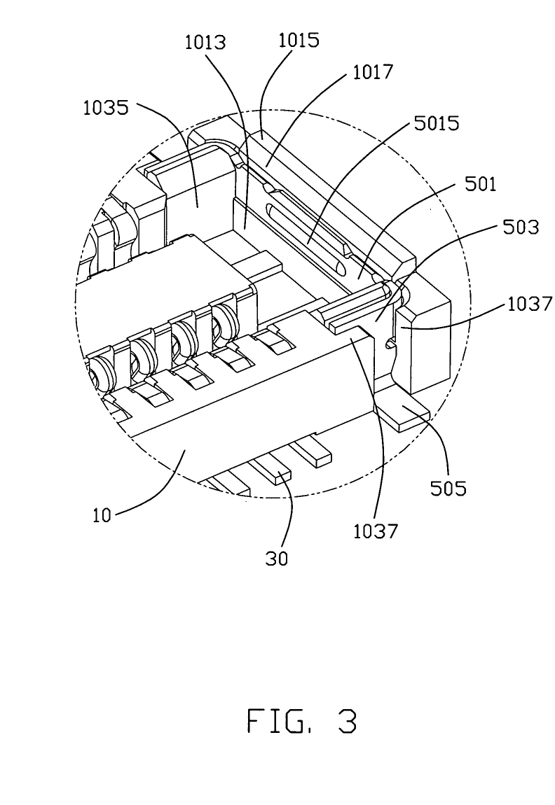

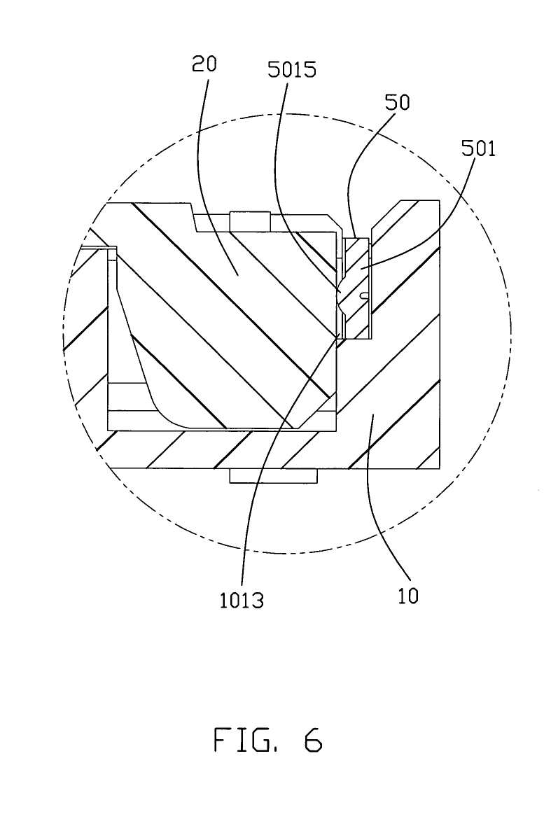

Referring to drawings, FIGS. 1-7 illustrate an embodiment of the electrical connector assembly constructed in accordance with the principles of the present invention. It can be seen that the electrical connector assembly comprises a pair of connector component 1, 2 for connecting one printed circuit board 3 to another printed circuit board 4. The plug connector 1 is mounted on one printed circuit board 3, while the receptacle connector 2 is mounted on another printed circuit board 4 and engaged with the plug connector 1 for providing an electrical connection between the two opposite printed circuit board 3 and 4.

Referring now to FIG. 1 to 4, the plug connector 1 includes a housing 10 of an insulative material, such as plastic, a plurality of conductive terminals 30 arranged at regular intervals along the length of the connector 1, and a pair of reinforcing member 50 disposed at two end portions of the housing 10. The conductive terminals 30 are arranged in two distinct sets, or arrays, and are fixed to the insulative housing 10. The plug housing 10 has a rectangular central portion, shown as a pedestal 105. The center pedestal 105 has a substantially flat or planar top surface 1053 that permit the plug connector 1 to be assembled onto the corresponding printed circuit board 3 with a vacuum pick and place mechanism.

The pedestal 105 is surrounded by two opposite first and second sidewalls 101, 103, wherein the first sidewalls 101 extend along a widthwise direction, while the second sidewalls 103 extend along a length direction. And the pedestal 105 and the first and second sidewalls 101, 103 cooperately form a mating channel 107 for receiving the receptacle connector 2. Each of the second sidewalls 103 does not extend to and connect with the first sidewalls 101, but connect with each other with a connecting wall 1035 located between the first and second sidewall 101, 103 and extending in the length direction. But the thickness of the connecting wall 1035 is thinner than that of the second sidewall 103 so that an opening 1033 is formed thereof. In addition, two opposite block walls 1037 are defined in the opening 1033, one extending from an end side of the second sidewall 103 towards a center of the opening 1033 and integrate formed with the second sidewall 103, while the other extending from an inner surface of the first sidewall 101 towards the center of the opening 1033 and integrate with the first sidewall 101, therefore, a recess 1039 is formed between the block walls 1037 and the corresponding connecting wall 1035 and the recess 1039 is crossed with the opening 1033. Furthermore, a step 1013 is defined on a position which adjacent to the mating channel 107 and integrately formed with the first sidewall 101. An upper end of said connecting wall 1035 only extends from the end side of the second sidewall 103 to an inner surface of said step 1035, therefore a slit (not labeled) is formed between a side edge of the upper end of the connecting wall 1035 and the inner surface of the corresponding first sidewall 101, by which said recess 1039 is run-through the mating channel 107 and the width of the slit is equal to the thickness of the step 1013. In addition, the height of the step 1013 is lower than that of the first sidewalls 101. And a top surface of each first sidewall 101 defines a strip 1015, the length of which is not less than a distance between the opposite connecting walls 1035. Each of the strips 1015 and the connecting walls 1035 defines a slant surface 1017 extending from a corresponding top surface towards corresponding inner surface thereof in order to lead the receptacle connector 2.

Each inner surface of the second sidewalls 103 defines a plurality of terminal-receiving slots 1031 extending from an upper surface to a bottom surface of the housing 10, and a plurality of accepting slots 1051 are formed in an out-surface of the pedestal 105 and extending from an upper surface to a bottom surface thereof. In addition, each of the terminal-receiving slots 1031 is opposite to corresponding accepting slot 1051, by this, each conductive terminal 30 is retained between the terminal-receiving slot 1031 and the accepting slot 1051.

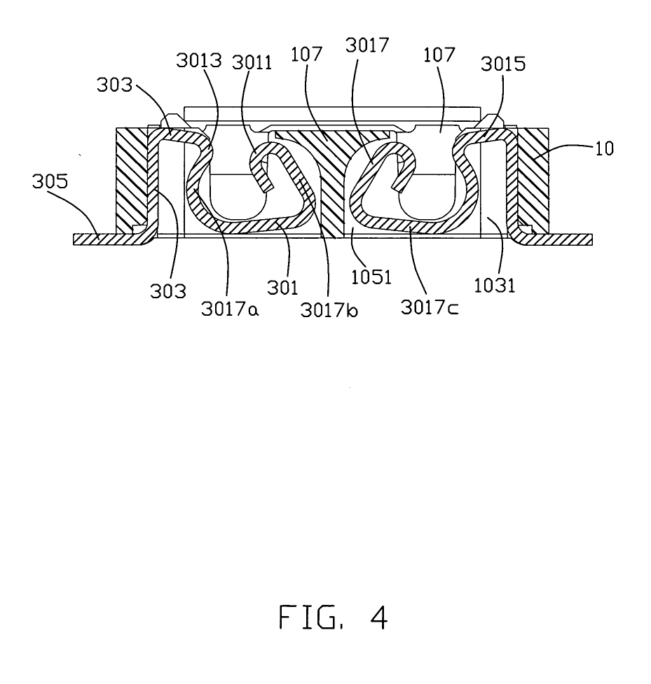

The conductive terminals 30 used in the plug connector 1 may be formed from metal blanks in a know manner, such as by stamping and forming. As shown in FIGS. 1 and 4, each conductive terminal 30 includes a solder tail 305 extending along a horizontal direction, a retention portion 303 extending uprightly from an end edge of the solder tail 305, and an elastic portion 301 extending curly from an upper edge of the retention portion 303. Said elastic portion 301 includes a ceil portion 3015 extending horizontally and slantly from an upper edge of the retention portion 3031, and a U-shaped portion 3017, wherein the U-shaped portion includes two opposite first and second legs 3017a, 3017b and a connecting portion 3017c therebetween. The first leg 3017a firstly extrudes from the upper edge of the ceil portion 3015 towards a center of the mating channel 107, after extrudes towards the retention portion 303 and forms a U-shape. The connecting portion 3017c firstly extending along the horizontal direction and then slightly slant upward. Said portion formed on the first leg 3017a and extruding towards the center of the mating channel 107 forms a first contact engaging portion 3013, and a distal end of the U-shaped portion 3017 defines a second contact engaging portion 3011 bending towards a center of the U-shape portion 3017 and forming a reversed U-shape.

Now also referring to FIG. 1, the reinforcing member 50 is formed from metal plate and comprises a base portion 501, two opposite arms 503, each extending forwardly from an end side of the base portion 501, two opposite legs 507, each extending downwardly from a bottom edge of the corresponding arm 503, and two opposite tail portions 505, each extending horizontally and outwardly from a distal end of a corresponding leg 507. Wherein, a strip dimple 5015 is formed on a contacting surface of the base portion 501 thereof. When the reinforcing member 50 is assembled into the housing 10, the base portion 501 is located on a top surface of the step 1013 so that the base portion 501 is a part of the mating channel 107 and the strip portion 1051 explosured into the mating channel 107 in order to contact engaging with an outer-surface of the housing 30 of the receptacle connector 2. Additionally, the arms 503 of the reinforcing member 50 is received in the recess 1039 and abut against with the outer surface of the connecting wall 1035, therefore, the intensity of the connecting wall 1035 is strengthen and it is not been cracked.

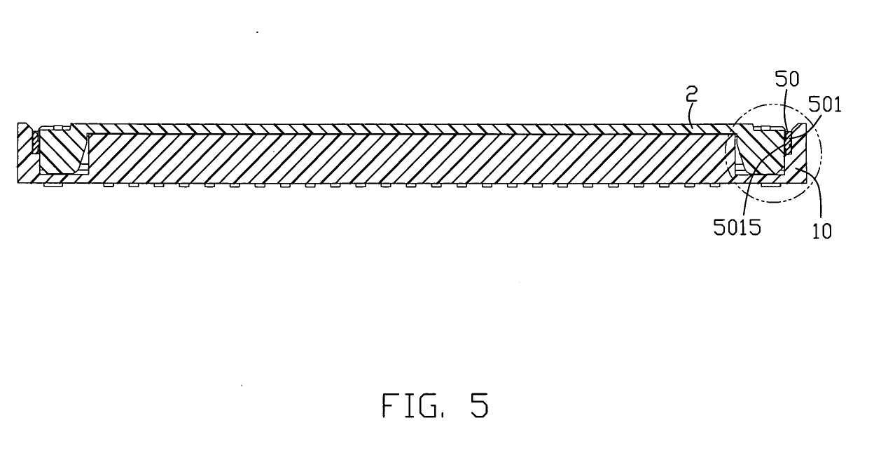

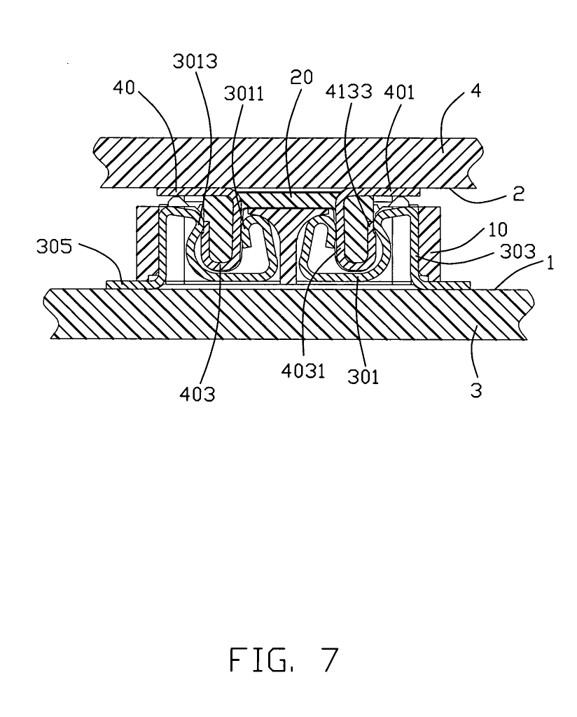

Now please refer to FIGS. 5 and 7, it can be seen that the other connector component 2 takes the form of a receptacle connector and includes an insulative housing 20 of plastic and a plurality of contacts 40 longitudinally arranged in the insulative housing 20 at regular intervals in two distinct sets. The insulative housing is designed for mating with the counterpart housing of the plug connector 1.

Each contact 40 used in the receptacle connector 2 is also preferably formed from metal blanks by stamping and forming. Each contact 40 includes soldering tail 401 extending horizontally and a U-shaped portion 403. The U-shaped portion 403 includes two opposite first and second legs 4031, 4133. The first leg 4031 is connected with the solder tail 401 and the second leg 4033 is disposed in a free position of the U-shaped portion 403. Please particularly refer to FIG. 7, the second leg 4033 defines a contact engaging portion (not labeled) located on an end portion thereof, which concaved from an out surface thereof, and adapted for engaging with the first contact engaging portion 3013 of the conductive terminal 30 of the plug connector 1.

FIGS. 5 and 7 illustrates the two plug and receptacle connector components 1 and 2 mated together. Please particularly refer to FIG. 7, the solder tail 305 of the conductive terminals 30 of the plug connector 1 are soldered to one printed circuit board 3, whereas the solder tail 401 of the contacts 40 of the receptacle connector 2 are soldered to the other printed circuit board 4. The mating channel 107 of the housing 10 of plug connector 1 is positioned over the receptacle connector insulastive housing sidewalls and the plug and receptacle connector 1 and 2 are pressed together into engagement. At this time, the U-shaped portion 403 of the contact 40 of the receptacle connector 2 is completely inserted into the U-shaped portion 3017 of the conductive terminals 30 of the plug connector 1. In the course of the receptacle connector 2 assembling into the plug connector 1, the first and second contact engaging portion 3013 and 3011 of the conductive terminals 30 of the plug connector 1 didn't slid on the out surface of the legs 4031 and 4033 of the contacts 40 of the receptacle connector 2 until the first contact engaging portion 3013 of the conductive terminals 30 of the plug connector 1 engaged with the contact engaging portion of the second leg 4133 of the contacts 40 of the receptacle connector 2, at this time, the first contact engaging portion 3013 of the conductive terminals 30 of the plug connector 1 is engaging with the out-surface of the first leg 4031 of the contact 40 of the receptacle connector 2 and the second contact engaging portion 3011 of the conductive terminals 30 of the plug connector 1 is engaging with the contact engaging portion of the second leg 4133 of the contact 40 of the receptacle connector 2. Since the contact engaging portion of the second leg 4133 of the contact 40 of the receptacle connector 2 is concaved from the out surface of the second leg 4133 of the contact 40 of the receptacle connector 2, it is difficult that the receptacle connector 2 is pulled out from the plug connector 1. Additionally, there has two opposite first and second contact engaging portion 3013 and 3011 on the conductive terminal 30 of the plug connector 1 adapted for engaging with the corresponding portions of the contact 40 of the receptacle connector 2, therefore, it is provides a reliable electrical connection between the plug connector component 1 and the receptacle connector component 2.

Now please particularly refer to FIG. 5, when the plug connector 1 has completely mated with the receptacle connector 2, because the reinforcing member 50, particular the base portion 501 thereof, is exposured into the mating channel 107, the reinforcing member 50 will distort towards the first sidewall 101 of the plug connector 1 and finally contact with the out surface of the insulative housing 20 of the receptacle connector 2 with the strip dimple 5015.

In the above description of the preferred embodiment, the plug connector component 1 further includes a reinforcing member 50 having a base portion 501 explosured into the mating channel 107 and contacting engage with the housing of the receptacle connector component with the strip portion 5015. Therefore, it can provide a reliable electrical connection between the opposite printed circuit board 3 and 4.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector comprising:
a housing defining a longitudinal central slot with contact terminals arranged on side walls thereof, the central slot having opposite first and second end portions, and having traversal wall and longitudinal wall sections; and
first and second metallic aligning pads arranged on the end portion and having a base section substantial flushed to the transversal wall, and a wing section reinforcing the longitudinal wall sections.

2. The electrical connector as recited in claim 1, wherein the base portion of each metallic aligning pad is arranged on an inner surface of the transversal wall and configured as a part of the central slot, and the wing is arranged on an external surface on the longitudinal wall.

3. The electrical connector as recited in claim 2, wherein the end portion of the longitudinal wall defines a connecting wall with a slit formed between the connecting wall and the transversal wall, through which the wing of the metallic aligning pad is arranged on the external surface of the longitudinal wall.

4. The electrical connector as recited in claim 3, wherein the thickness of the connecting wall is thinner than that of the longitudinal wall.

5. The electrical connector as recited in claim 4, wherein two opposite blocks are formed on the end portion of the longitudinal wall, and an opening is formed between the blocks and penetrated with the slit.

6. The electrical connector as recited in claim 5, wherein a recess is formed between an inner surface of the blocks and the external surface of the connecting wall and crossed with the slit adapted for receiving the wings of the metallic aligning pad.

7. The electrical connector as recited in claim 6, wherein the recess defines a flat supporting surface adapted for supporting the metallic aligning pad.

8. The electrical connector as recited in claim 7, wherein central slot defines a supporting portion aligned with the flat supporting surface adapted for supporting the base portion of the metallic aligning pad, when metallic aligning pad is assembled into the housing, it is located on a top face of the supporting portion.

9. The electrical connector as recited in claim 1, wherein each end portion of each transversal wall and longitudinal wall defines a leading portion with a slant surface extending from a top surface thereof to corresponding inner surface thereof.

10. The electrical connector as recited in claim 9, wherein the central slot further defines a center pedestal extending upwardly.

11. A electrical connector interconnection, comprising:
a first connector having an insulative housing defines a longitudinal slot with contact terminals arranged on side walls thereof, the longitudinal slot having opposite first and second internal end portions, first and second metallic pads arranged on the end portions and having a main plate substantial flushed to an end wall of the end portion; and
a second connector mated with the first connector and comprising external end portion properly abutting against the metallic pads so as to facilitate smooth and correction interconnection between the first and second connector.

12. The electrical connector interconnection as recited in claim 11, wherein the main plate of the metallic pad is arranged between the external end portion of the second connector and the internal end portion of the first connector.

13. The electrical connector interconnection as recited in claim 11, wherein the main plate will distort between the external end portion of the second connector and the internal end potion of the first connector in the course of the first and second connector is mated.

14. The electrical connector interconnection as recited in claim 13, wherein the main plate further including a strip located between the main plate and the external end portion of the second connector.

15. The electrical connector interconnection as recited in claim 11, wherein each first terminal including a soldering portion extending along a horizontal direction, an upright retention portion, and an elastic portion, wherein the elastic portion includes a ceil portion extending horizontally from an upper edge of the retention portion and a U-shaped portion extending curly from an end of the ceil portion with two opposite first and second contact engaging portion, wherein one of the first and second contact engaging portion disposed on a distal end of the U-shaped portion and configured as a reversed U-shape.

16. An electrical connector comprising:
an insulative housing defining a mating port surrounded by two opposite lengthwise side wall and two opposite end walls;
a pair of mounting pads disposed at two opposite end walls, each of said mounting pads including a U-shaped upper section received in a corresponding U-shaped recess around the corresponding end wall, and a pair of L-shaped mounting legs each having an upper vertical retaining section and a lower surface mounting section; wherein
each of said lengthwise side wall defines an opening extending therethrough in a vertical direction to allow downward passing of the corresponding mounting leg during assembling the mounting pad to the housing.
